(19) United States
(12) Patent Application Publication
(10) Pub. No.: US 2001/0044237 A1
(43) Pub. Date: Nov. 22, 2001

(54) ELECTRICAL JUMPER CONNECTOR

(76) Inventor: GUY LOUIS LETOURNEAU, WARREN, OR (US)

Correspondence Address: PAUL WEINSTEIN ESQ, PERMAN & GREEN LLP, 425 POST ROAD, FAIRFIELD, CT, 06430

(21) Appl. No.: 09/428,175

(22) Filed: Oct. 27, 1999

(51) Int. Cl. H01R 31/08

(52) U.S. Cl. 439/625

(57) ABSTRACT

An electrical connector device or jumper for electrically connecting two or more electrical terminals. The electrical connector comprises a conductive bridging member having opposing first and second ends. The bridging member extends in a first direction. Each of the ends of the bridging member define opposing contact surfaces for making electrical contact with a terminal when it is admitted between the opposing contact surfaces. The contact surfaces are adapted to admit, or to allow removal of, the electrical terminal in a direction generally aligned with the first direction or in a direction generally transverse to the first direction.

### BACKGROUND OF THE INVENTION

1. Field of the Invention

This invention relates to an electrical connector or jumper for connecting two or more electrical terminals. The jumper is particularly useful for electrically interconnecting terminals on separate printed circuit boards. The jumper of this invention permits removal of a circuit board without having to first remove the jumper.

2. Brief Description Of Earlier Developments

Electrical connectors or jumpers are conventionally used to electrically interconnect two or more terminals. In one application the terminals are located on separate printed circuit boards which are electrically interconnected by the jumper connectors.

U.S. Pat. No. 3,488,620 to Sullivan et al., U.S. Pat. No. 4,033,657 to Kemper, U.S. Pat. No. 4,352,534 to Johnson, U.S. Pat. No. 4,449,771 to Carr, U.S. Pat. No. 4,470,652 to Schwab, and U.S. Pat. No. 4,516,817 to Deters, are illustrative of conventional jumpers. In these patents a jumper device or connector is pushed onto two or more pin type terminals in order to interconnect those terminals. The terminals may appear on a single device or a printed circuit board or may appear on multiple devices or printed circuit boards as in FIG. 1 of U.S. Pat. No. 4,033,657. The jumper is pressed onto the pins from above and can be removed from the pins by pulling in the reverse direction. In the electrical jumper connectors of these patents, the jumper can only engage or disengage the pins by movement in one direction such as a vertical direction. Therefore, if two circuit boards are interconnected by such a jumper, in order to remove one of the circuit boards, the jumper must first be removed. This can make assembly or disassembly of such a structure difficult.

In high current applications the terminals typically comprise “faston” blade-type terminals. In this case, an electrical connector or jumper is utilized for electrically joining two or more of such blade-type terminals together in order to transmit power between adjacent devices such as printed circuit boards.

U.S. Pat. No. 4,453,792 to Bright et al., U.S. Pat. No. 4,983,132 to Weidler, U.S. Pat. No. 5,013,252 to Nienhuis et al., and U.S. Pat. No. 5,030,108 to Babow et al. are illustrative of electrical connectors or jumpers for interconnecting such blade or faston type terminals. In each of these connectors however the terminals are inserted in a first direction and removed in the opposing direction. There is no provision in any of the conventional connectors, which would allow the terminals to be inserted into the connector in a first direction and removed in a direction opposing the first direction or inserted into the connector in a second direction normal to the first direction or removed in a direction opposite to the second direction or provide a combination of these movements.

When applied to interconnecting adjacent printed circuit boards, the approaches of the conventional devices cause difficulties when inserting or removing a circuit board. The jumpers described by reference to the pin-type terminals must be removed before the printed circuit boards are either removed or inserted. The jumpers which have been described by reference to faston or blade-type terminals only permit movement of the circuit board for insertion or removal in a single direction. This is a severe restriction on the assembly of the circuit boards into an array since the circuit board can be inserted or removed from the jumper in only one direction.

### SUMMARY OF THE INVENTION

In accordance with this invention an electrical connector device or jumper is provided for electrically connecting two or more electrical terminals. The electrical connector comprises a conductive bridging member having first and second ends and extending in a first direction. Each of the ends of the bridging member define opposing contact surfaces for making electrical contact with a terminal when it is admitted between the opposing contact surfaces. The contact surfaces are adapted to admit, or to allow removal of, the electrical terminal in a direction generally aligned with the first direction or in a direction generally transverse to the first direction.

In accordance with a preferred embodiment of the invention, the bridging member comprises a central channel section having a “U” shaped cross section. In this embodiment the ends of the bridging member define the opposing contact surfaces and comprise at each of the ends opposing cantilever portions projecting outwardly from the central channel section. The opposing cantilever portions preferably comprise opposing plates.

In accordance with a further preferred embodiment of this invention, retention structure is provided which gives a recognizable effect upon complete engagement of a terminal with the contact surfaces. Preferably the retention structure is a projection. Each of the plates preferably includes first free edges extending generally aligned to the first direction and second free edges extending generally transverse to the first direction. Each of the free edges preferably has an outwardly flared guide lip for guiding the terminals during insertion between the opposing plates.

In a further embodiment of the invention a plurality of such bridging members are provided. An insulative housing is preferably provided for supporting such a plurality of bridging members.

The electrical connector of this invention is particularly applicable for use in combination with two adjacently disposed circuit substrates together. Preferably the circuit substrates include a plurality of blade contacts with corresponding blade contacts from each substrate being be connected by the plurality of bridging members of the electrical connector of this invention.

### BRIEF DESCRIPTION OF THE DRAWINGS

FIG. 1 is a perspective view of a bridging member useable in an electrical connector device in accordance with a preferred embodiment of this invention.

FIG. 2 is a perspective view of an electrical connector device in accordance with a preferred embodiment of this invention which includes a plurality of conductive bridging members.

FIG. 3 is a partial cross-sectional view of an electrical connector housing and a bridging member in accordance with a preferred embodiment of this invention.

### DETAILED DESCRIPTION OF THE PREFERRED EMBODIMENTS

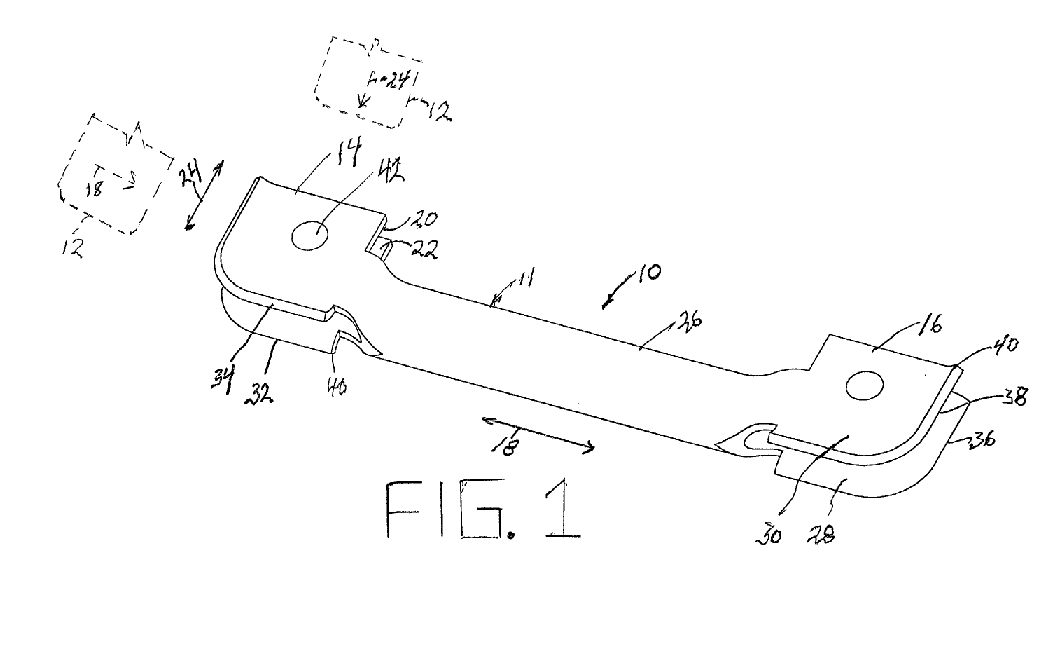

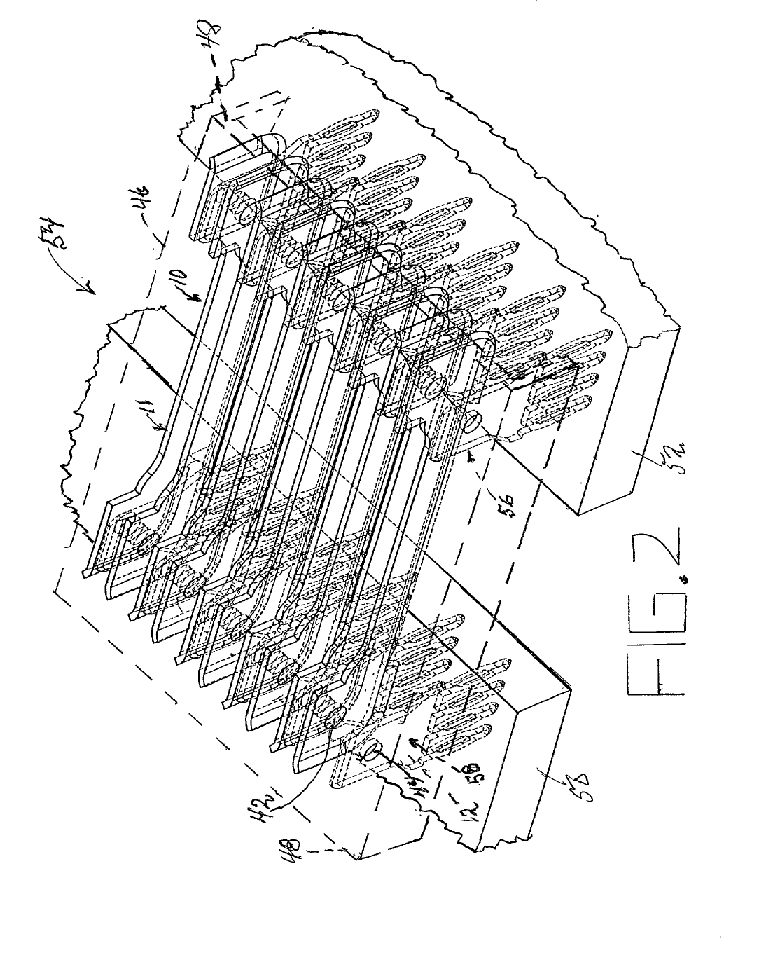

Although the present invention will be described with reference to the embodiments shown in the drawings it should be understood that the present invention may be embodied in many forms of alternative embodiments. In addition any suitable size, shape or type of materials or elements could be used. Referring now to FIGS. 1 and 2 there is shown an electrical connecting device 10 in accordance with a preferred embodiment of this invention. The electrical connector 10 is typically referred to as a “jumper” and it is used to electrically and mechanically mate two terminals 12 together, each typically located on a respective adjacent circuit substrate. The electrical connector comprises a conductive bridging member 11 having opposing first and second ends 14 and 16 in a first direction as illustrated by arrow 18. Each of the ends 14 and 16 of the bridging member 11 define opposing contact surfaces 20 and 22.

The contact surfaces 20 and 22 make electrical contact with a terminal 12 when it is admitted or inserted between the opposing contact surfaces 20 and 22. The contact surfaces 20 and 22 are adapted to admit or to be removed from the electrical terminal 12 (as shown in phantom) in a direction (as shown by arrow 18) generally aligned with or parallel to the first direction 18 and in a direction (as shown by arrow 24) that is generally transverse to or perpendicular or normal to the first direction. The directions 18 and 24 are shown with reverse arrows since the movement of the bridging member 11 would be in one general direction for insertion of a terminal and in the opposing general direction for removal of the terminal.

The electrical connector device 10 of this invention accepts or releases contacts or terminals 12 inserted or extracted from the side or from below (a seen, for example in FIG. 1), in either or any direction. The benefit of this feature is that during installation or disassembly of substrates, such as printed circuit boards 50 and 52, on which the faston blade terminals 12 are mounted, the boards 50 and 52 can be moved into position or extracted without first removing the electrical connector device 10 of this invention. In the aforementioned conventional jumpers, removal of the jumpers is usually required before the first array 56 of faston blade terminals 12 can be moved relative to the second array 58 of such terminals 12 on a neighboring printed circuit board 50 or 52.

Using the electrical connecting device 10 of this invention this constraint of removing the jumper 10 before removing a printed circuit board 50 or 52 is eliminated and the constraint of installing both boards 50 and 52 before installing the jumper 10 is also eliminated. The connector device 10 of this invention permits a printed circuit board 50 or 52 to be installed or removed while leaving the jumper 10 in place on one of the boards.

The electrical connector device 10 of this invention is particularly useful with blade or faston type terminals 12 as exemplified in FIG. 2. The electrical connector device 10 in accordance with a preferred embodiment comprises a bridging member 11 which is preferably stamped and formed from a sheet of a conductive metal or alloy and includes a central channel section 26 having a “U” shaped cross section. The ends 14 and 16 of the bridging member 11 comprise opposing cantilever portions 28 and 30 which project outwardly from the central section 26. These opposing cantilever portions 28 and 30 preferably have a plate-like configuration, however, they may have any desired contact configuration, including non-symmetrical configurations, for mating with any desired terminal shape.

Each of the plates 28 and 30 includes first free edges 32 and 34, which are generally parallel to the first direction 18 and second free edges 36 and 38 which are generally perpendicular or normal to the first direction and are arranged essentially parallel to the direction of arrow 24. The free edges 32 through 36 preferably include an outwardly flared guide lip 40 to act as a lead-in for guiding terminals 12 during insertion between opposing plates 28 and 30. Preferably, the spacing between plates 28, 30 allows for insertion of terminal 12 in an interference fit. The resiliency of plates 28, 30 provides a suitable contact normal force.

In accordance with a particularly preferred embodiment of this invention, the electrical connector device 10 has contact surfaces 20 and 22 which include retention structure such as a detent 42 for providing a recognizable effect upon complete engagement of a terminal 12 with the contact surfaces 20 and 22. The recognizable effect can comprise any desired recognizable effect including, for example, a marked tactile sensation, an audible noise or a discernable shift in mating force or any other visible, audible, or notable effect. The detent 42 comprises a dimple in each plate 28 and 30 which results in a corresponding domed or convex surface (not shown) projecting from the contact faces 20 and 22 of each end 14 and 16 of the bridging member 11. This dimple-like projection 42 or domed projection is adapted to locate on a hole 44 in the terminal 12. This provides a secure mechanical mating of the bridging member 11 to the terminal 12 and provides a desired marked tactile sensation. Conventional techniques can be used to form detent 42 on bridging member 11.

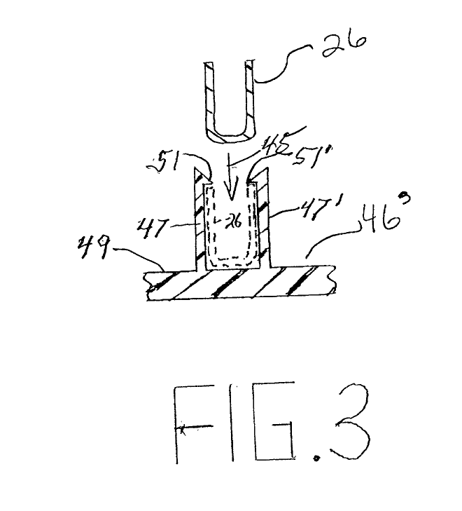

Referring now to FIG. 2 an electrical connector 54 in accordance with a particularly preferred embodiment of this invention is shown which comprises a plurality of bridging members 11. The bridging members 11 are supported within an insulative housing 46 which is shown in phantom. The housing 46 can have any desired shape or design for supporting the plurality of bridging members 11. For example, the housing 46 can be overmolded about the bridging members 11 or it can comprise a plastic member into which the bridging members are snapped in place or inserted as shown in FIG. 3. In order for the electrical connector 10 to be removable or insertable in the general directions of arrows 18 and 24 the ends 48 of the housing 46 are left open. While only one end wall is shown at each side of the housing 46 there can also be intermediate walls (not shown) arranged between each of the bridging members 11 to provide separation and to maintain spacing.

In FIG. 3 there is shown a partial cross-sectional view of a preferred embodiment of a housing 46′ into which the channel portion 26 of the bridging member 11 can be snapped. In this embodiment, opposing snap members 47 and 47′ extend in cantilever fashion from the top 49 of the housing 46′. Snap member 47 is spaced from snap member 47′ by an amount which will allow the channel portion 26 to slide between the snap members. At the free end of each snap member there is provided a locking projection 51 or 51′ extending outwardly from the plane of the snap member 49 or 49′ in the direction of the opposing snap member 49 or 49′.

In operation of the embodiment of FIG. 3, a channel portion 26 of the bridging member 11 is pressed into the housing member 46′ in the direction of arrow 45by inserting it between the snap members 49 and 49′. The snap members 49 and 49′ are spread open (not shown) at the locking projections 50 and 50′ to admit the channel portion 26 until it is seated as shown in phantom. Thereafter the snap members 49 and 49′ snap back to their original position as shown in FIG. 3 so that the locking projections 50 and 50′ extend over the edges of the channel portion 26 locking the bridging member 11 in place in the housing 46′.

Alternatively, any desired housing member 46 could be employed which would support the bridging members 11. The plurality of bridging members 11 are preferably arranged parallel to one another as shown.

In the exemplary embodiment of FIG. 2 two printed circuit boards 50 and 52 are electrically and mechanically mated by an electrical connector 54 of this invention. Each of the circuit boards 50 and 52 can include a linear array 56 or 58 of blade-type terminals 12 which are embedded in the circuit boards 50 and 52. Each blade terminal 12 includes a hole 44 into which the dome shaped projections 42 from the contact faces 20 and 22 of the plates 28 and 30 of the bridging member 11 seat when the connector 10 is fully seated on the circuit boards 50 and 52.

The “U” shaped central section 26 of each bridging member 11 provides strength to the resilient plates 28, 30 during engagement and disengagement of the connector assembly 54 with terminals 12. The bridging member 11 is designed to electrically connect and to mechanically secure one blade terminal 12 to another. The opposing pairs of internal contact surfaces 20 and 22 preferably are designed to admit a blade terminal 12 in a direction parallel to the arrow 18 and also in a direction normal to this direction which is parallel to arrow 24. This advantageously removes constraints on the methods and order of assembly of a first and second printed circuit board 50 and 52 having a linear arrays 56 and 58 of blade contacts.

The connector 10 of this invention, by preferably providing two opposed flared plate portions 28 and 30 or hands which clasp a blade type terminal 12 therebetween, provides contact points on a terminal which are directly opposed to each other rather than staggered contact points on a terminal which might result in an unbalanced force that bends the terminal 12. In accordance with this embodiment of the invention the connector 10 provides a simple pinch on the terminal 12. It is preferred in accordance with this invention to use two plate type contact surfaces 20 and 22 or planar contact surfaces. However, if desired an asymmetrical embodiment could be employed (not shown) wherein one of the plates 28 of the connector 10 at either or both ends 14 and 16 could comprise a planar surface and the opposing plate 30 at that end could have a convex surface.

In accordance with a preferred embodiment, each end 14, 16 can secure a corresponding terminal 12 with a different amount of retention force. This allows for the removal of the terminal 12 retained with a lower retention force without disengaging the terminal 12 retained by a higher retention force.

It should be understood that the foregoing description is only illustrative of the invention. Various alternatives and modifications can be devised by those skilled in the art without departing from the spirit of the invention. Accordingly, the present invention is intended to embrace all such alternatives, modifications and variances which fall within the spirit and scope of the appended claims.

What is claimed is:

1. An electrical connector device for electrically connecting two electrical terminals comprising:
a conductive bridging member having first and second ends and extending in a first direction;
each of said ends of said bridging member defining opposing contact surfaces for making electrical contact with a terminal when it is admitted between said opposing contact surfaces, said contact surfaces being adapted to admit, or to allow removal of, the electrical terminal in a direction generally aligned with said first direction and in a direction generally transverse to said first direction.

2. An electrical connector as in claim 1 wherein said bridging member comprises a central channel section have a “U” shaped cross-section and wherein said ends of said bridging member defining said opposing contact surfaces comprise, at each of said ends, opposing cantilever portions projecting from said central section.

3. An electrical connector as in claim 2 wherein said opposing cantilever portions comprise opposing plates.

4. An electrical connector as in claim 3 wherein said contact surfaces include retention structure for providing a recognizable effect upon complete engagement of a terminal with said contact surfaces.

5. The electrical connector as recited in claim 4, wherein said retention structure comprises a projection.

6. An electrical connector as in claim 3 wherein each of said plates includes first free edges generally aligned said first direction and second free edges generally transverse to said first direction, and wherein said free edges have an outwardly flared guide lip for guiding said terminals during insertion between said opposing plates.

7. An electrical connector as in claim 1 comprising a plurality of said bridging members.

8. An electrical connector as in claim 7 further including an insulative housing supporting said plurality of bridging members.

9. An electrical connector as in claim 7 in combination with two adjacently disposed circuit substrates together.

10. An electrical connector as in claim 9 wherein each of said circuit substrates includes a plurality of blade contacts with corresponding blade contacts from each board being connected by said plurality of bridging members.

11. A method of removing a component from an electrical system, comprising the steps of:
providing an electrical system, comprising:
a first substrate with at least one terminal;
a second substrate with at least one terminal; and
at least one jumper contact;
connecting said at least one jumper contact to said at least one terminal of said first substrate and said at least one terminal of said second substrate, to interconnect said system; and
disconnecting said first substrate from said at least one jumper contact without disconnecting said second substrate and said at least one jumper contact.

12. The method as recited in claim 11, wherein said first and second substrates are printed circuit boards.

13. The method as recited in claim 11, wherein the connecting step occurs in a first direction and the removing step occurs in a second direction angled relative to said first direction.

14. The method as recited in claim 13, wherein said second direction is generally transverse to said first direction.
